(19) United States
(12) Patent Application Publication
(10) Pub. No.: US 2025/0335491 A1
(43) Pub. Date: Oct. 30, 2025

(54) AUTOMATIVE SEMANTIC TENANT INDEX ONBOARDING

(71) Applicant: Microsoft Technology Licensing, LLC, Redmond, WA (US)

(72) Inventors: Radhika JOSHI, Redmond, WA (US); Aigerim SHINTEMIROVA, Redmond, WA (US); Charlie CORREDOR, Seattle, WA (US); Marissa Lisette GARCIA, Redmond, WA (US); Jae Dong HWANG, Redmond, CA (US); Julien J.T. PIERRE, Redmond, WA (US); Varadarajan Subramaniam THIRUVILLAMALAI, Bellevue, WA (US); Christoffer Benjamin ROSEN, Seattle, WA (US); Dimitrios VOUTSAS, Redmond, WA (US); Yuva Priya ARUNKUMAR, Redmond, WA (US); Suyang JIANG, Redmond, WA (US); Shan Hasan RIZVI, Redmond, WA (US); Mengdong YANG, Sammamish, WA (US)

(21) Appl. No.: 18/649,527

(22) Filed: Apr. 29, 2024

(51) Int. Cl. G06F 16/36; G06F 16/31; G06F 16/33

(52) U.S. Cl. CPC G06F 16/367; G06F 16/328; G06F 16/3347

(57) ABSTRACT

A computer-implemented method for managing the lifecycle of a semantic index within a cloud-based environment is disclosed. The method involves detecting a signal indicating a tenant's eligibility for semantic indexing and, in response, identifying tenant-specific content for vectorization based on predefined criteria. Semantic vectors are generated from the identified content and stored in a primary index storage. These vectors are then propagated to a secondary index storage, where a semantic index is built from the propagated vectors. The method further includes enabling semantic queries based on the semantic index within the secondary index storage.

### TECHNICAL FIELD

The subject matter disclosed herein generally relates to the management of semantic indexes in a distributed cloud computing environment. Specifically, the present disclosure addresses systems and methods for enhancing search and query functionalities for tenant-specific data within a scalable vector database framework.

### BACKGROUND

In cloud computing and data management, the ability to efficiently search and retrieve information from vast datasets is paramount. Many search technologies rely on matching keywords, which can result in imprecise results because they do not understand the context and connections between the data. As enterprises continue to generate and store an ever-increasing volume of diverse data types, including but no limited to documents, emails, chats, and multimedia content, the need for advanced search capabilities that can interpret and process this data semantically has become critical.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a cloud-based semantic indexing platform in accordance with one example embodiment.

FIG. 3 illustrates an onboarding service in accordance with one example embodiment.

FIG. 4 illustrates an offboarding service in accordance with one example embodiment.

FIG. 5 illustrates an index management service in accordance with one example embodiment.

FIG. 6 illustrates a query enablement module in accordance with one example embodiment.

FIG. 7 is a flow diagram illustrating a method for enabling semantic query in accordance with one example embodiment.

FIG. 8 is a flow diagram illustrating a method for enabling queries on semantic index in accordance with one example embodiment.

FIG. 9 is a flow diagram illustrating a method for detecting a tenant offboarding event in accordance with one example embodiment.

FIG. 10 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The technical problem addressed by the present disclosure arises from the limitations of conventional search technologies within cloud-based, multi-tenant data environments. Traditional search methods primarily rely on keyword matching, which often fails to capture the nuanced meanings and relationships inherent in complex datasets. As a result, users may experience suboptimal search outcomes, characterized by irrelevant results and inefficient data retrieval processes. This challenge is compounded in multi-tenant environments, where each tenant's dataset is unique and continually evolving, necessitating a search solution that is both contextually aware and dynamically adaptable.

Moreover, the management of semantic indexes, which underpin the functionality of semantic search technologies, presents additional difficulties. These indexes should be created, maintained, and eventually decommissioned in a manner that is both resource-efficient and responsive to the changing nature of the data they represent. The process of updating these indexes to reflect new or altered data, as well as purging them when they become obsolete, requires significant computational resources and manual oversight. Without an automated system in place, the task of index lifecycle management can become a bottleneck, leading to increased costs and potential disruptions in service availability, and impact to customer search experience.

The present disclosure addresses these technical problems by introducing an automated lifecycle management system for semantic indexes within a cloud-based, multi-tenant environment. To manage the lifecycle of these semantic indexes, the system incorporates an automation engine that orchestrates the entire process, from index creation to decommissioning. The system generates semantic indexes that accurately reflect the meaning and context of the data. These semantic indexes enable more effective search capabilities, allowing users to retrieve information that is not only relevant but also semantically aligned with their queries. The system is designed to handle the dynamic nature of cloud data, automatically updating indexes as new data is ingested or existing data is modified. The system also ensures that indexes are purged efficiently when tenants leave the system or when the data they represent is no longer needed or available. By automating these processes, the system significantly reduces the computational overhead and manual intervention required, leading to a more scalable and cost-effective solution.

In one example embodiment, a system and method for managing a lifecycle of a semantic index for tenants in a cloud-based environment is described. The method includes detecting a signal indicating a tenant eligibility for semantic indexing, in response to detecting the signal, identifying tenant-specific content for vectorization based on criteria, generating semantic vectors from the identified tenant-specific content and storing the semantic vectors in a primary index storage, propagating the semantic vectors from the primary index storage to a secondary index storage, building a semantic index from the semantic vectors stored in the secondary index storage, and enabling semantic queries on the secondary index storage based on the semantic index.

As a result, one or more of the methodologies described herein facilitate solving the technical problem of manually updating semantic indexes to reflect new or altered data, as well as purging them when they become obsolete. As such, one or more of the methodologies described herein may obviate a need for certain efforts or computing resources. Examples of such computing resources include processor cycles, network traffic, memory usage, data storage capacity, power consumption, network bandwidth, and cooling capacity.

The term “tenant” used herein, refers to a customer or an organization that subscribes to cloud services provided by a host company. The term can also be used in cloud computing and software-as-a-service (SaaS) models to describe an independent instance of the software application and its associated data. Each tenant's data is isolated and remains invisible to other tenants. In the specific context of the present application, a tenant would be an entity, such as a company or organization, that uses the cloud-based platform for creating, managing, and utilizing semantic indexes for their data, which could include files, emails, and other content types (e.g., videos, chart, text, audio).

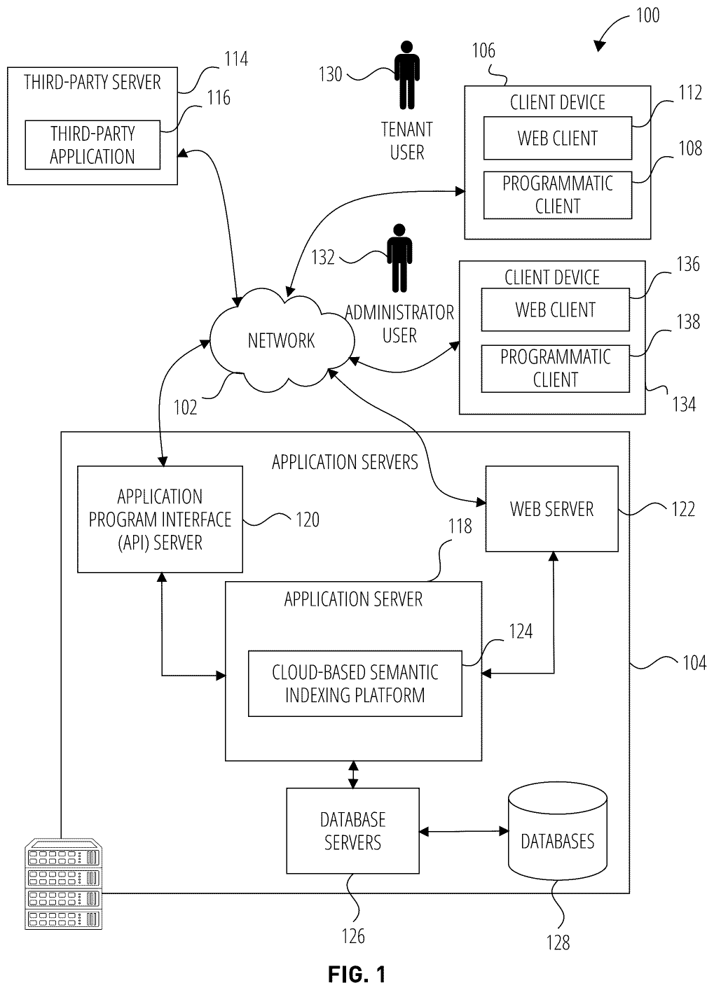

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106 and client device 134. A tenant user 130 operates the client device 106. The client device 106 includes a web client 112 (e.g., a browser) and a programmatic client 108 (e.g., an incident management application) that is hosted and executed on the client device 106. An administrator user 132 operates the client device 134. The client device 134 includes a web client 136 and a client device 134.

The administrator user 132 is typically responsible for the configuration, management, and oversight of cloud-based semantic indexing platform 124's operations from an administrative perspective. The administrator user 132 has elevated privileges that allow them to set up and modify the system settings, manage user access controls, and oversee the overall health and security of the cloud-based semantic indexing platform 124. For example, administrator user 132 is responsible for tasks such as onboarding new tenant users, configuring index management settings, and monitoring the system for operational issues. Administrator user 132 has the authority to deploy updates, manage backups, and restore operations to ensure the cloud-based semantic indexing platform 124's continuity and resilience against data loss or corruption.

Furthermore, the administrator user 132 can access detailed and system level logs and reports that provide insights into the system's performance, usage patterns, and potential security threats. This enables the administrator user 132 to make informed decisions about system enhancements, capacity planning, and security measures to optimize the platform's efficiency and safeguard the data.

The tenant user 130 refers to individuals who are consumers of the cloud-based semantic indexing platform 124's capabilities within a specific tenant environment. The tenant user 130 interacts with cloud-based semantic indexing platform 124 primarily through web client 112 or programmatic client 108, to perform various data-related tasks that leverage the semantic indexing functionalities of the cloud-based semantic indexing platform 124.

In one example, the tenant user 130 queries the semantic index to retrieve information, inputting new data into the system for indexing, and utilizing the platform's search capabilities to enhance their operational workflows. Tenant user 130 operates within a multi-tenant environment where data segregation and access controls are enforced to protect sensitive information and comply with data governance policies.

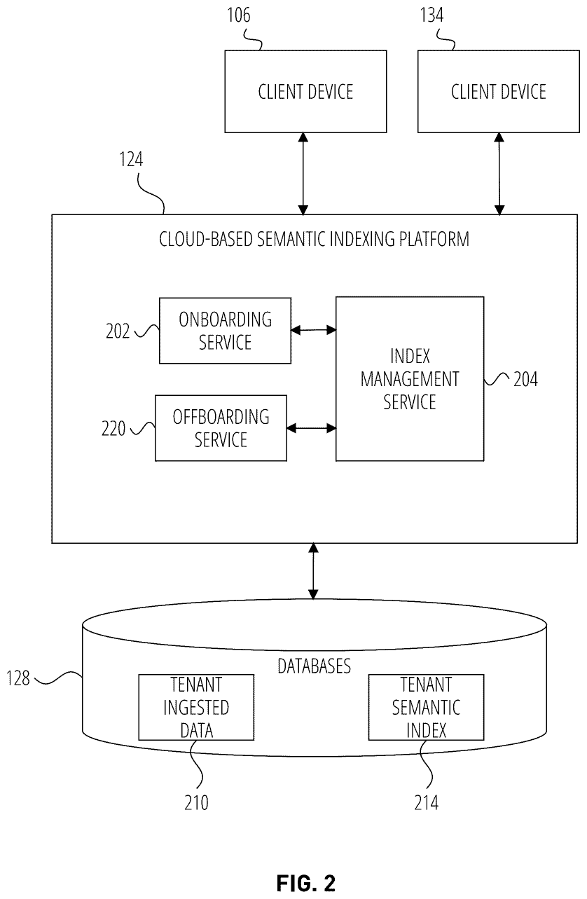

An Application Program Interface (API) server 120 and a web server 122 provide respective programmatic and web interfaces to application servers 104. A specific application server 118 hosts a cloud-based semantic indexing platform 124 that includes components, modules, and/or applications (described in more detail below with respect to FIG. 2.

The cloud-based semantic indexing platform 124 includes a server-side application. In one example, the cloud-based semantic indexing platform 124 is a platform that transforms large volumes of unstructured and structured data into semantically enriched, searchable indexes. The cloud-based semantic indexing platform 124 handles the ingestion of raw data from multiple sources, applies semantic analysis techniques, and generates semantic vectors that capture the underlying meanings and relationships within the data.

In one example, the cloud-based semantic indexing platform 124 provides a comprehensive lifecycle management system for semantic indexes, for maintaining the efficiency and relevance of the data available to users. This lifecycle management system encompasses several stages: initialization, vectorization, propagation, index building, query enablement, and cleanup. Each stage is designed to ensure that the semantic indexes are not only accurate and up-to-date but also optimized for performance and scalability.

During the initialization and onboarding phase, the cloud-based semantic indexing platform 124 begins with the initialization or onboarding process, where new tenant data is introduced into the system. During this stage, the cloud-based semantic indexing platform 124 identifies the specific data sets that need to be indexed and prepares the system for data ingestion. This involves setting up the necessary configurations and parameters based on the tenant's requirements and the nature of the data. The onboarding process sets the foundation for the subsequent indexing and ensures that the system is aligned with the tenant's data structure and semantic needs.

During the vectorization phase, once the data is onboarded, the cloud-based semantic indexing platform 124 proceeds to the vectorization stage. Here, the raw data is processed and transformed into semantic vectors. This involves analyzing the content of the data, understanding its context, and converting it into a format that can be easily indexed and searched. The vectorization process uses natural language processing (NLP) techniques and machine learning algorithms to capture the nuanced meanings and relationships within the data. This stage creates a rich semantic layer that enhances the search capabilities of the cloud-based semantic indexing platform 124.

During the index propagation and building phase, after vectorization, the semantic vectors are propagated from the primary index storage to secondary storage systems. This propagation ensures that the data is replicated across the platform's infrastructure, enhancing data durability and accessibility. Following propagation, the cloud-based semantic indexing platform 124 builds the semantic index by organizing the propagated vectors (stored in the secondary storage system) into a structured format that can be efficiently queried. The index building process is optimized to handle large volumes of data and to update the indexes incrementally as new data arrives or existing data is modified.

During the query enablement phase, with the indexes built, the cloud-based semantic indexing platform 124 sets up mechanisms to allow users to query the semantic indexes. For example, the cloud-based semantic indexing platform 124 ensures that the indexes are complete (or exceed a predefined completeness threshold) and ready to serve queries by implementing checks and balances that assess the integrity and completeness of the indexes. Once the indexes are deemed ready, the cloud-based semantic indexing platform 124 systematically enables query functionalities, allowing users to start retrieving information based on their search criteria.

Finally, during the cleanup and decommissioning phase, the cloud-based semantic indexing platform 124 includes a cleanup stage where outdated or unnecessary indexes are decommissioned and removed from the system. This stage maintains the efficiency of the cloud-based semantic indexing platform 124, as it prevents the accumulation of stale data that can degrade performance. The cleanup process is managed to ensure that data integrity is maintained and that all dependencies are resolved before any data is removed. An example embodiment of the cloud-based semantic indexing platform 124 is described further below with respect to FIG. 2.

The application server 118 is shown to be communicatively coupled to database servers 126 that facilitates access to an information storage repository or databases 128. In an example embodiment, the databases 128 include storage devices that store information to be processed by the cloud-based semantic indexing platform 124.

Additionally, a third-party application 116 may, for example, store another part of the cloud-based semantic indexing platform 124, or include a cloud storage system. For example, the third-party application 116 stores other resource utilization data related to the application servers 104. In another example, the third-party server 114 is associated with another server farm that is different from the server farm of the application servers 104. The third-party application 116 executing on a third-party server 114, is shown as having programmatic access to the application server 118 via the programmatic interface provided by the Application Program Interface (API) server 120. For example, the third-party application 116, using information retrieved from the application server 118, may support one or more features or functions on a website hosted by the third party.

FIG. 2 is a schematic diagram illustrating the architecture of a cloud-based semantic indexing platform and its various components involved in the lifecycle management of a tenant's data for onboarding, semantic indexing, querying, and offboarding. In one example embodiment, cloud-based semantic indexing platform 124 includes onboarding service 202, index management service 204, and offboarding service 220.

Onboarding service 202 is responsible for initiating the process of bringing a new tenant onto the cloud-based semantic indexing platform 124 and handles the initial setup and configuration required to start the semantic indexing process for the tenant's data. In one example, the detection of a signal indicating a tenant's eligibility for semantic indexing within a cloud-based environment involves a series of technical steps and systems designed to ensure accurate and timely identification of eligibility criteria. This process is for dynamically managing access to semantic indexing services based on tenant status, subscription level, or other predefined criteria. Examples of how the signal is detected include:

Tenant Management System Integration: The cloud-based semantic indexing platform 124 is typically integrated with a tenant management system (TMS), which maintains comprehensive records of all tenants, including their current subscription status, service entitlements, and any changes to their accounts. The TMS is responsible for triggering events or signals when there are updates to a tenant's status that might affect their eligibility for semantic indexing services.

Event-Driven Architecture: The cloud-based semantic indexing platform 124 employs an event-driven architecture where services listen for specific events broadcasted by the TMS. These events include notifications of subscription upgrades, renewals, or any modifications in the service agreements that could alter a tenant's eligibility. Each event carries metadata that includes the tenant ID, the nature of the event, and other relevant details necessary to assess the impact on indexing services.

Eligibility Criteria Engine: Upon receiving an event, a dedicated eligibility criteria engine evaluates whether the changes affect the tenant's access to semantic indexing. This engine is configured with rules that define eligibility based on various factors such as subscription level, data usage quotas, compliance status, and other relevant parameters. The engine processes the event data against these rules to determine if the tenant should be granted or revoked access to the indexing services.

Signal Generation and Dissemination: If the eligibility criteria engine determines that a tenant's status has changed in a way that affects their indexing services, it generates a signal indicating this change. This signal is then disseminated to the semantic indexing service and other dependent systems via a messaging queue or a similar asynchronous communication system. This ensures that the signal is handled efficiently without impacting the performance of the core systems.

Indexing Service Configuration: Upon receiving the signal, the semantic indexing service updates its configuration to either enable or disable indexing features for the affected tenant. This might involve provisioning new resources, adjusting data ingestion pipelines, or updating access controls and permissions. The service also logs the change for audit purposes and may trigger notifications to the tenant or system administrators to inform them of the change in service status.

Continuous Monitoring and Feedback Loop: The system continuously monitors the status of all tenants and the integrity of the signals being processed. This monitoring helps in quickly identifying any discrepancies or failures in the signal detection and handling processes. Feedback from the monitoring systems can be used to refine the eligibility rules and improve the accuracy and responsiveness of the eligibility criteria engine.

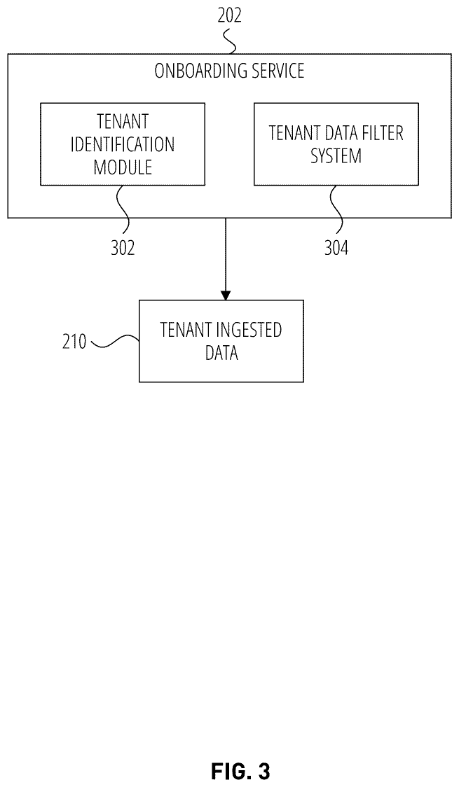

In another example, when a tenant subscribes to the service of cloud-based semantic indexing platform 124, onboarding service 202 takes charge of setting up configurations and parameters to tailor the semantic indexing process to the tenant's specific needs. Onboarding service 202 initiates the process by identifying and preparing the tenant's data for vectorization, which is the first step in creating a semantic index. Onboarding service 202 also ensures that the tenant's data is correctly (and efficiently) ingested into the system and that all the prerequisites for semantic indexing are met, laying the groundwork for the subsequent steps in the semantic index lifecycle, such as vector generation, index building, and ultimately, enabling the tenant to perform semantic queries on their data. An example embodiment of onboarding service 202 is described in more detail below with respect to FIG. 3.

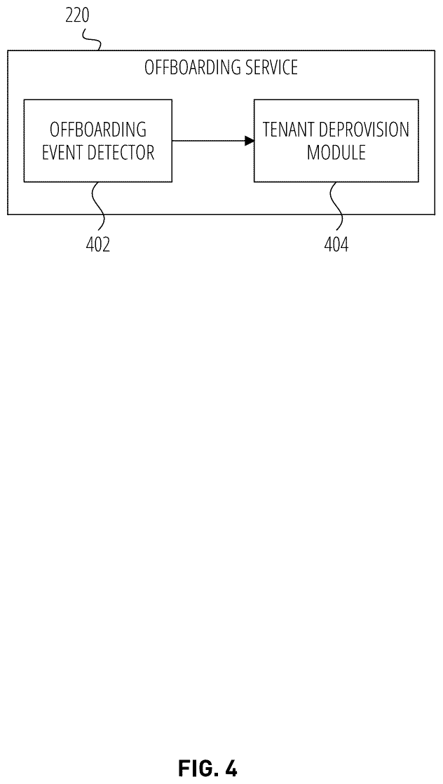

Offboarding service 220 manages the process of removing a tenant from the cloud-based semantic indexing platform 124. For example, offboarding service 220 ensures that all semantic indexes and related data are properly decommissioned and that the tenant's data is cleaned up from the system when they decide to leave or when their subscription ends. In one example, the admin administrator user 132 does not have access to the tenant's data. An example embodiment of offboarding service 220 is described in more detail below with respect to FIG. 4.

Index management service 204 oversees the ongoing maintenance and updates of the semantic index. Index management service 204 ensures that the index is up-to-date with the latest tenant data changes, including but not limited to additions, deletions, or modifications, to maintain the accuracy and relevance of the semantic index over time. For example, index management service 204 oversees the entire index lifecycle, which includes the bootstrap module for initializing new indexes, the vectorization module for converting textual content into semantic vectors, and the index propagation module for distributing these vectors from primary to secondary storage locations. Additionally, the index management service 204 is responsible for the index building module, which aggregates and integrates updates into the existing indexes, and the query enablement module, which activates the index for responding to search queries. Index management service 204 also removes outdated or unnecessary indexes, ensuring optimal performance and resource utilization. By managing these diverse yet interconnected processes, the index management service 204 ensures that tenants have access to a semantic index that is both reflective of their current data and optimized for efficient query resolution, thereby enhancing the search functionality and user experience.

Databases 128 are the storage components that house data accessible for processing by the platform's services. In one example, databases 128 includes tenant ingested data 210 and tenant semantic index 214.

Tenant ingested data 210 represents the raw data provided by the tenant, which includes various types of content such as documents, emails, and other data sources. This data is the input for the semantic indexing process.

Tenant semantic index 214 is the output of the indexing process. It is a structured representation of the tenant's data that allows for efficient and meaningful search and retrieval based on semantic understanding. For example, tenant semantic index 214 involves the extraction of semantic vectors from the ingested data, which encapsulates the essence and contextual nuances of the content. These vectors are then organized into a graph structure that represents the semantic relationships and similarities between different pieces of content. This graph-based approach enables the tenant semantic index 214 to support complex queries that go beyond simple keyword matching, allowing for more intuitive and relevant search results based on the conceptual understanding of the data. The tenant semantic index 214 is continuously updated and refined as new data is ingested and processed, ensuring that the index remains current and reflective of the tenant's evolving data landscape.

FIG. 3 illustrates the onboarding service 202 in accordance with one example embodiment. The onboarding service 202 includes a tenant identification module 302 and a tenant data filter system 304. The tenant identification module 302 identifies and authenticates tenant data as it enters the cloud-based semantic indexing platform 124, ensuring that the data is correctly associated with the respective tenant and that all subsequent operations maintain data integrity and security.

In one example, tenant identification module 302 authenticates data, verifies the tenant, tags, and categorizes the data. Upon receiving data, the tenant identification module 302 verifies the authenticity of the data source. This ensures that the data being processed is indeed from the registered and verified tenants, thereby preventing unauthorized access or data breaches. The tenant identification module 302 also checks the credentials and rights of the tenant to ensure that the entity interacting with the platform is authorized to do so. This step maintains multi-tenant security and compliance with data governance policies. Once the data is authenticated and the tenant is verified, the tenant identification module 302 tags the data with tenant-specific identifiers. This tagging process enables for tracking the data throughout its lifecycle in the system and ensuring that all operations performed on the data are tenant-specific and isolated from other tenants' data. After identifying and verifying the tenant data, the data is passed to tenant data filter system 304.

The tenant data filter system 304 filters and processes incoming tenant data (after identifying and verifying the tenant data) based on predefined criteria and configurations, ensuring that only relevant and permissible data is ingested into the cloud-based semantic indexing platform 124 for indexing. In one example, tenant data filter system 304 performs data filtering, data classification, and data enrichment.

The tenant data filter system 304 applies various filters to the incoming data. These filters might include criteria based on data type, content relevance, security classifications, and compliance requirements. By filtering out irrelevant or non-compliant data, the tenant data filter system 304 ensures that the cloud-based semantic indexing platform 124's resources are utilized efficiently, and that the data stored and indexed is of the highest relevance and quality.

Beyond simple filtering, the tenant data filter system 304 classifies the incoming data into different categories. This classification aids in the organization of data within the tenant data filter system 304 and enhances the effectiveness of the indexing process. Data can be classified based on its source, content type, urgency, confidentiality level, and other relevant attributes.

In another example, before passing the data along to the next stages of processing, the tenant data filter system 304 may also enrich the data by adding metadata or transforming the data into a format more suitable for indexing. This enrichment process helps in building a more robust and searchable index. The filtered data are stored as the tenant ingested data 210. As such, the tenant ingested data 210 includes only relevant and permitted data ingested into the cloud-based semantic indexing platform 124 to optimize the indexing process and enhance the overall efficiency of the cloud-based semantic indexing platform 124.

FIG. 4 illustrates the offboarding service 220 in accordance with one example embodiment. The offboarding service 220 includes an offboarding event detector 402 and a tenant deprovision module 404.

The offboarding event detector 402 detects and responds to events indicating that a tenant is terminating their use of the platform's services. The offboarding event detector 402 initiates the subsequent processes that ensure data is securely and efficiently decommissioned in accordance with both organizational policies and regulatory requirements. In one example, the offboarding event detector 402 performs the following functions: event detection, notification and confirmation, and initiation of offboarding protocols.

For the event detection function, the offboarding event detector 402 continuously monitors for signals or triggers that indicate a tenant is preparing to leave or has decided to terminate their services. These triggers could be explicit, such as a direct notification from the tenant's administrative interface, or implicit, such as the expiration of a contract without renewal.

Upon detecting an offboarding trigger, the offboarding event detector 402 generates notifications to relevant administrative personnel or systems. This step often includes mechanisms to confirm the intent to offboard, ensuring that the process is initiated intentionally and with full awareness of the tenant.

Once an offboarding event is confirmed, the offboarding event detector 402 initiates the offboarding protocols. This includes notifying tenant deprovision module 404 to begin the processes of data archiving, deletion, and other cleanup tasks as specified by the platform's policies and the tenant's agreement.

In another example embodiment, the offboarding event detector 402 includes an event monitoring system (to continuously scan for signals indicating offboarding intentions), an automated workflow (to ensure that once an offboarding event is detected, all subsequent actions are automatically triggered without unnecessary delays), and security protocols (to maintain the integrity and confidentiality of the tenant's data throughout the offboarding process, ensuring that data is handled in compliance with legal and regulatory standards).

The tenant deprovision module 404 handles the decommissioning and secure removal of tenant data and configurations from the cloud-based semantic indexing platform 124 once an offboarding event is detected by the offboarding event detector 402. The tenant deprovision module 404 performs the following functions:

Data Sanitization and Deletion: this involves the secure and thorough removal of all tenant data from the cloud-based semantic indexing platform 124. This process includes the deletion of data from primary and secondary storage systems, ensuring that no residual data remains that could potentially be recovered or misused.

Resource Cleanup: beyond data deletion, the tenant deprovision module 404 also handles the cleanup of any resources that were allocated to the tenant, such as virtual machines, network configurations, and cached data. This ensures that the cloud-based semantic indexing platform 124's resources are efficiently reallocated and that there is no lingering resource utilization that could affect platform performance.

Archiving and Compliance: in some cases, regulatory requirements may necessitate the archiving of data for a certain period even after a tenant has been deprovisioned. The tenant deprovision module 404 manages the archiving process, ensuring that data is securely stored and accessible in compliance with legal obligations.

Notification and Logging: throughout the deprovisioning process, the tenant deprovision module 404 maintains a log of all actions taken and notifies relevant stakeholders of the progress. This transparency is crucial for audit trails and for maintaining trust with remaining and prospective tenants.

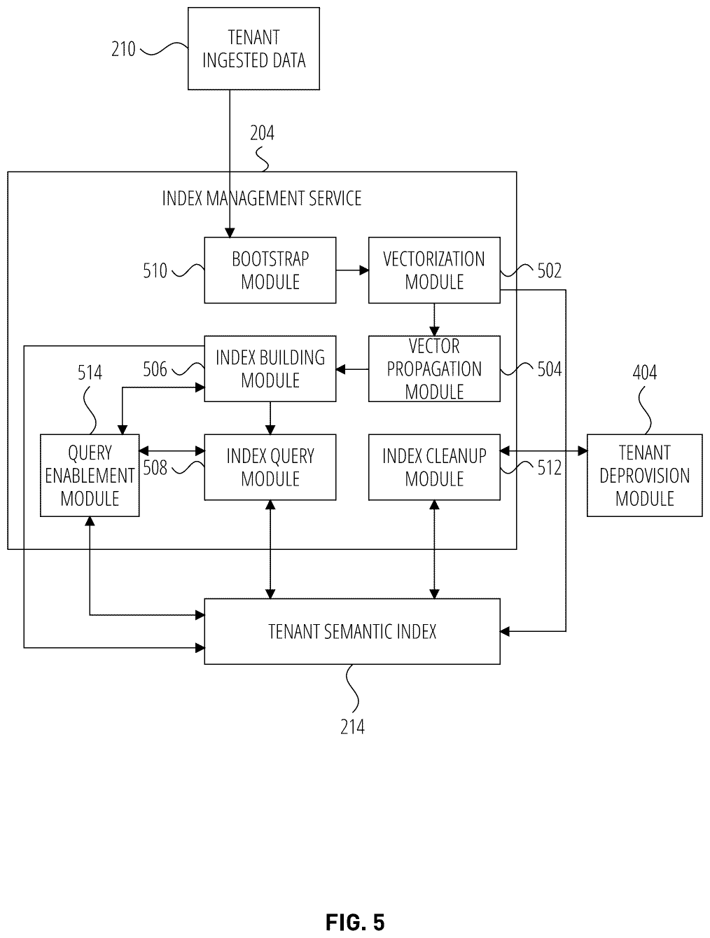

FIG. 5 illustrates the index management service 204 in accordance with one example embodiment. The index management service 204 includes a bootstrap module 510, a vectorization module 502, a vector propagation module 504, an index building module 506, an index query module 508, a query enablement module 514, and an index cleanup module 512.

The bootstrap module 510 is the initial phase that sets up the groundwork for efficient and effective semantic indexing of tenant data. This process involves several steps and components that work together to ensure that the index management service 204 is correctly configured and ready to handle the data it will process.

The following illustrates an example of the bootstrap process of bootstrap module 510:

Step 1: Initialization. The bootstrap process begins with the configuration of the indexing system. This includes setting up server parameters, allocating resources like memory and processing power, and configuring network settings to ensure optimal data transfer rates and connectivity. Essential software components and dependencies are installed and configured. This might include database management systems, data processing frameworks, and specific indexing software that the platform relies on.

Step 2: Data Schema Analysis. In this step, the bootstrap module 510 retrieves the data schema associated with the tenant's data. This schema provides a blueprint of the data structure, including details about data types, relationships, and other metadata. Advanced algorithms interpret the schema to understand the relationships and hierarchies within the data. This understanding is for building a semantic index that accurately reflects the nuances of the data.

Step 3: Metadata Setup. Alongside the schema, metadata associated with the data is extracted. Metadata might include information about data creation dates, modification history, access permissions, and other contextual details. Based on the schema and metadata, the bootstrap module 510 establishes a set of rules and parameters for indexing. These rules determine how data will be processed and indexed, ensuring that the semantic index is both comprehensive and efficient.

Step 4: Resource Allocation. The bootstrap module 510 assesses the volume and complexity of the data to dynamically allocate the necessary computational resources. This ensures that the indexing process runs smoothly without overloading the system resources. The bootstrap process also plans for scalability, setting parameters that allow the bootstrap module 510 to scale up resources as data volume increases or as more complex indexing tasks are initiated.

Step 5: Vectorization and Index Building Preparation. Before the actual data processing begins, the bootstrap module 510 sets up the initial conditions for vectorization. This includes configuring vectorization algorithms and loading necessary libraries and tools. The bootstrap module 510 prepares for the index-building phase by setting up index structures, defining index storage formats, and configuring index management tools.

Step 6: Triggering Subsequent Processes. Once the initial setup is complete, the bootstrap process triggers the vectorization module 502, which begins the process of converting raw data into semantic vectors.

The vectorization module 502 is responsible for transforming raw tenant data into semantic vectors, which are then used to build and update the semantic index. The vectorization process enables efficient and effective search capabilities within the cloud-based semantic indexing platform 124 by converting unstructured data into structured, queryable formats.

The following illustrates an example process of how the vectorization module 502 generates semantic vectors:

Data Input and Preprocessing: The vectorization module 502 receives raw data from various tenant sources. This data can include documents, emails, chats, and other forms of unstructured or semi-structured data. Before vectorization, the data undergoes preprocessing to clean and normalize it. This step might involve removing noise, standardizing formats, and extracting useful features that are relevant for vectorization. This step can also be performed by the bootstrap module 510.

Semantic Analysis and Feature Extraction: For text data, the vectorization module 502 applies NLP techniques to analyze the semantic content of the text. This includes tokenization, part-of-speech tagging, and named entity recognition, which help in understanding the context and meaning of the words within the data. The vectorization module 502 extracts semantic features from the data for creating meaningful vectors. These features represent the semantic properties of the data and are selected based on their relevance to the search and indexing functions of the cloud-based semantic indexing platform 124.

Vectorization: Using the extracted features, the vectorization module 502 encodes the data into semantic vectors. These vectors are high-dimensional numerical representations that capture the semantic relationships and contextual meanings of the original data. To improve efficiency and performance, the vectorization module 502 applies dimensionality reduction techniques to the vectors, reducing the number of dimensions while preserving the semantic relationships.

Vector Optimization and Storage: The vectors are optimized for storage and retrieval. This includes compressing the vectors to reduce storage space and enhancing them for faster query performance. Once optimized, the vectors are stored in a vector database (e.g., databases 128) or a similar storage system that supports high-dimensional data. This storage system is designed to facilitate efficient querying and retrieval of vectors.

Integration with Index Building: After vectorization, the vectors are handed off to the vector propagation module 504 and index building module 506 which uses these vectors to construct and update the tenant semantic index 214. The vectorization module 502 also handles updates to existing data. When data changes or new data is added, the vectorization module 502 updates the corresponding vectors, ensuring that the tenant semantic index 214 remains accurate and up-to-date.

In another example embodiment, the vectorization module 502 is designed to scale horizontally to handle large volumes of data. This scalability is achieved through distributed processing and efficient management of computational resources. The quality of vectorization impacts the effectiveness of the tenant semantic index 214. As such, the vectorization module 502 incorporates advanced machine learning and AI techniques to ensure that the vectors accurately represent the semantic content of the data.

The vector propagation module 504 is responsible for the distribution and synchronization of semantic vectors across different storage locations within the cloud-based semantic indexing platform 124, ensuring that the semantic index is consistently updated and accessible across the cloud-based semantic indexing platform 124. The propagation process is for ensuring redundancy and facilitating easier access during querying.

The following illustrates example functions of the vector propagation module 504:

Vector Transfer Initiation: The process begins when new semantic vectors are generated and stored in the primary index storage. The vector propagation module 504 monitors this storage for any changes or new additions and triggers the propagation process when updates are detected. Before transferring the vectors, the vector propagation module 504 may perform additional data preparation steps, such as compression or encryption, to optimize the transfer and ensure data security during transit.

Data Transfer Mechanisms: To optimize network usage and system performance, vector propagation module 504 often batches multiple vector updates together for propagation. This approach reduces the number of individual transfer operations and can help in managing system resources more efficiently. In one example, vector propagation module 504 utilizes advanced data transfer protocols that are optimized for high-speed and reliable data transmission. This ensures that vector data is quickly and securely transferred between the primary and secondary storages.

Redundancy and Data Integrity: By replicating semantic vectors from the primary to secondary index storage, the vector propagation module 504 ensures that there are multiple copies of the data. This redundancy is for data recovery and availability, particularly in the event of hardware failures or other system issues. In one example, the secondary index storage, being optimized for read operations, facilitates faster and more efficient query responses. The vector propagation module 504 ensures that the propagated vectors are readily accessible and properly indexed to support quick retrieval during query operations. After the data transfer, the vector propagation module 504 performs consistency checks to ensure that the vectors in the secondary storage are exact replicas of those in the primary storage. This step is for maintaining data integrity across the system.

Error Handling and Recovery: The vector propagation module 504 continuously monitors the propagation process for any errors or interruptions. Common issues might include network failures, data corruption, or unauthorized access attempts. In case of errors, vector propagation module 504 includes mechanisms in place to retry the transfer, recover corrupted data, or roll back changes as needed. These recovery actions help in maintaining the continuity and reliability of the vector propagation process.

Once the vectors are successfully propagated to the secondary storage, the vector propagation module 504 notifies the index building module 506. This notification triggers the index building process using the newly propagated vectors.

The index building module 506 is responsible for constructing and updating the semantic index using the semantic vectors that have been propagated from the primary index storage to the secondary index storage. In one example embodiment, using the propagated vectors, the index building module 506 builds the tenant semantic index 214 in the secondary index storage. The tenant semantic index 214 is used to facilitate efficient and effective search and retrieval operations. The following illustrates example functions of the index building module 506:

Index Construction: The index building module 506 starts its process by receiving semantic vectors from the vector propagation module 504. These vectors contain the processed and structured data necessary for building the semantic index. For new indices, the index building module 506 initializes the index structure, setting up the necessary data schemas and storage configurations that will hold the indexed data. This setup is for optimizing the performance and storage efficiency of the tenant semantic index 214.

Index Updating: The index building module 506 supports incremental updates to the tenant semantic index 214, where only new or changed vectors are added to the existing index. This capability is for maintaining the index up-to-date without the need to rebuild the entire index from scratch. For example, the index building module 506 detects changes in the incoming vectors and determines the parts of the tenant semantic index 214 that need updating. This selective updating helps minimize the processing load and reduces the time required for updates.

Data Integration and Synthesis: The index building module 506 merges incoming vectors with the existing index data, ensuring that the index remains consistent and comprehensive. Beyond simple merging, the index building module 506 synthesizes new information from the incoming data, enhancing the index's ability to provide relevant and context-aware search results.

Optimization and Performance Tuning: After building or updating the tenant semantic index 214, the index building module 506 performs various optimization operations to enhance the index's performance. These optimizations may include, for example, compressing the index data, reorganizing the index structure, and tuning the index parameters based on the query patterns observed. In another example, the index building module 506 continuously monitors its performance, collecting metrics such as index build time, index integrity, update latency, and query response times. These metrics are used to further fine-tune the tenant semantic index 214 and improve its efficiency.

Once the tenant semantic index 214 is built, the query enablement module 514 enables semantic queries on the tenant semantic index 214. The query enablement module 514 is tasked with enabling and managing the querying capabilities of the tenant semantic index 214 once it has been sufficiently built and is ready to serve user queries. The process of enabling queries refers to a switch or transition from a non-queryable state to a queryable state of the tenant semantic index 214.

The following illustrates example functions of the query enablement module 514:

Index Readiness Assessment: The query enablement module 514 continuously monitors the completeness of the semantic index build process. For example, the query enablement module 514 assesses whether the index has reached a predefined threshold of completeness necessary for starting query operations. This threshold might be defined in terms of the percentage of data indexed or specific performance metrics met. The threshold may be empirically determined based on previous data from the same tenant, other tenants, a type of data, or an elapsed-time threshold. In another example, the threshold may be x number of days that have elapsed from when the build began (bootstrap) or when a % of stamp completion is reached (whichever comes first).

Query Activation: Once the index is deemed ready, the query enablement module 514 sets a query enablement flag to ‘true’. This action may be referred to as “flipping the query,” effectively switching the index's state to active, making it accessible for search and retrieval operations. The query enablement module 514 notifies other components of the application server 118, such as the search interfaces and application servers, that the index is now ready for querying. This ensures that all parts of the system are synchronized and prepared to handle incoming search requests.

Query Configuration and Optimization: The query enablement module 514 configures various settings related to query processing, such as timeout settings, cache configurations, and query routing policies. These settings are optimized based on the index characteristics and expected query load. To ensure optimal query performance, the query enablement module 514 may adjust certain parameters of the index based on initial query performance metrics. This tuning process is for maintaining fast response times and high accuracy in search results.

Monitoring and Feedback Loop: After enabling queries, the query enablement module 514 continuously monitors the query performance. Key metrics such as query latency, reliability, throughput, and success rates are tracked to ensure the system meets the expected service levels. Feedback from query logs and user interactions is analyzed to further refine and optimize the tenant semantic index 214 and query processing settings. This feedback loop helps in dynamically adjusting the system to improve efficiency and effectiveness.

The index query module 508 handles the execution of queries against the tenant semantic index 214, enabling tenants to retrieve relevant information based on their search criteria. The following illustrates example functions of the index query module 508:

Query Reception and Parsing: The index query module 508 receives query requests from the client device 106 of the tenant user 130. These queries can be in the form of simple keyword searches or more complex queries involving multiple parameters and conditions. Upon receiving a query, the index query module 508 parses and interprets the query to understand the search criteria and any specific requirements or filters. This parsing step is for correctly mapping the query to the underlying index structure.

Query Processing: After parsing, the query is translated into a format that can be efficiently executed against the tenant semantic index 214. This involves converting high-level query language into low-level database operations. The index query module 508 generates an execution plan for the query to determine the most efficient way to access the tenant semantic index 214 and retrieve the required data. This step may involve choosing between different indexing strategies or deciding the order of operations based on the query complexity and index configuration.

Data Retrieval: The index query module 508 accesses the tenant semantic index 214 to retrieve data that matches the query criteria. This involves scanning the index, filtering out irrelevant data, and gathering the relevant entries. In cases where the query involves aggregations or summaries, the index query module 508 processes the retrieved data to compute the required metrics or summaries.

Result Formatting and Delivery: Once the relevant data is retrieved and processed, the index query module 508 compiles it into a result set that is structured according to the query's output requirements. The formatted result set is then delivered back to the requesting client or service. The delivery mechanism ensures that the data is transmitted securely and efficiently, maintaining the integrity and confidentiality of the information.

The index cleanup module 512 is tasked with the deletion and cleanup of semantic indexes associated with tenants who are either deprovisioned or no longer require the indexing services. The index cleanup module 512 ensures that all data related to a tenant's semantic index is securely and completely removed from both primary and secondary index storages. The following illustrates example functions of the index cleanup module 512:

Detection of Cleanup Events: The index cleanup module 512 monitors for signals (from tenant deprovision module 404) indicating that a tenant has been deprovisioned or has decided to terminate the indexing services. This detection initiates the cleanup process. A part from automatic triggers, the index cleanup module 512 also handles explicit cleanup requests from system administrators or via automated system policies that dictate data retention schedules.

Data Identification and Access: Upon triggering a cleanup event, the index cleanup module 512 identifies all locations (both in primary and secondary storages) where the tenant's semantic index data (e.g., tenant semantic index 214) is stored. This involves querying system metadata and index mappings associated with the tenant. Before proceeding with data deletion, the index cleanup module 512 performs access control checks to ensure that it has the necessary permissions to modify and delete the index data, thus maintaining system security.

Secure Data Deletion: The index cleanup module 512 executes a secure deletion process where the semantic index data associated with the tenant is permanently removed from both primary and secondary index storages. This process is designed to ensure that the data cannot be recovered or reconstructed. After the deletion process, the index cleanup module 512 verifies that all data has been completely removed. This verification step is critical to ensure compliance with data protection regulations and to prevent any accidental data leaks.

Resource Reallocation and Cleanup: Post-deletion, the index cleanup module 512 handles the reallocation of resources that were previously dedicated to the tenant's index. This includes freeing up storage space and reallocating computational resources to other tenants or system processes. In addition to deleting the index, the index cleanup module 512 also cleans up any residual data or metadata that might have been generated during the indexing process. This ensures that the system remains efficient and free from clutter.

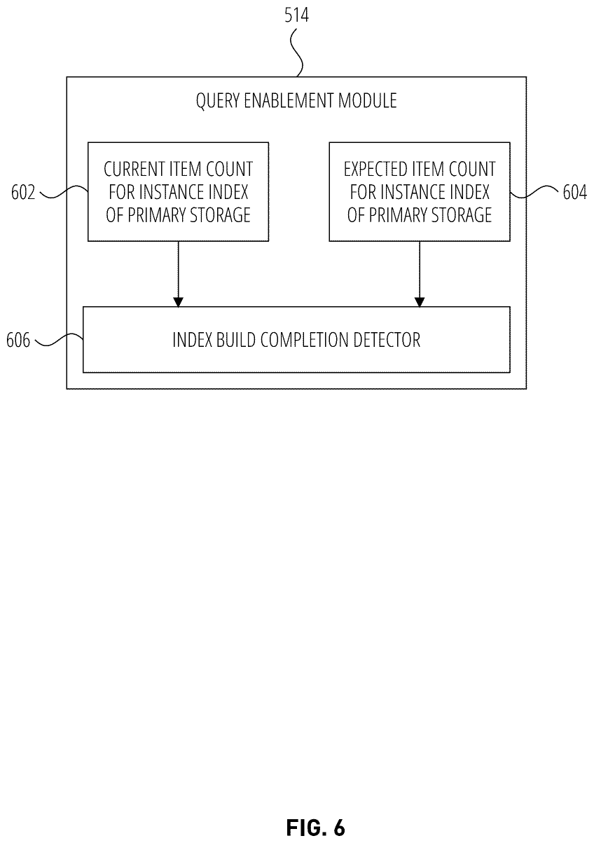

FIG. 6 illustrates the query enablement module 514 in accordance with one example embodiment. The query enablement module 514 includes a current item count for instance index of primary storage 602, an expected item count for instance index of primary storage 604, and an index build completion detector 606.

The current item count for instance index of primary storage 602 keeps track of the current number of items indexed in the primary storage for a specific instance. For example, the current item count for instance index of primary storage 602 continuously monitors and updates the count of items that have been successfully indexed in the primary storage. This real-time tracking provides up-to-date information about the state of the index.

The expected item count for instance index of primary storage 604 provides a benchmark or target for the number of items that should be indexed in the primary storage for a specific instance. For example, expected item count for instance index of primary storage 604 includes the expected number of items that should be indexed in the primary storage for each instance. This figure is typically based on the data ingestion forecasts, historical data trends, or specific system requirements. The expected item count can be dynamically adjusted by query enablement module 514 based on changes in data ingestion rates, modifications in project scope, or alterations in data retention policies. This flexibility ensures that the indexing targets remain aligned with the current operational needs.

The index build completion detector 606 determines the completion status of the index build process within the semantic indexing platform by comparing the current item count for instance index of primary storage 602 with the expected item count for instance index of primary storage 604. In one example, the index build completion detector 606 also analyzes the index integrity. In another example, the index build completion detector 606 determines whether the indexing process has indexed enough items to meet or exceed the predefined expectations. Typically, the completion of an index build is not only about meeting but potentially exceeding the expected item count to ensure robustness and account for any data inconsistencies or future expansions. If the current item count exceeds the expected item count, index build completion detector 606 interprets this as a successful completion of the index build. Upon determining that the index build is complete, index build completion detector 606 updates the system status to reflect this completion. This might involve setting a flag or updating a database entry that indicates the index is ready for use.

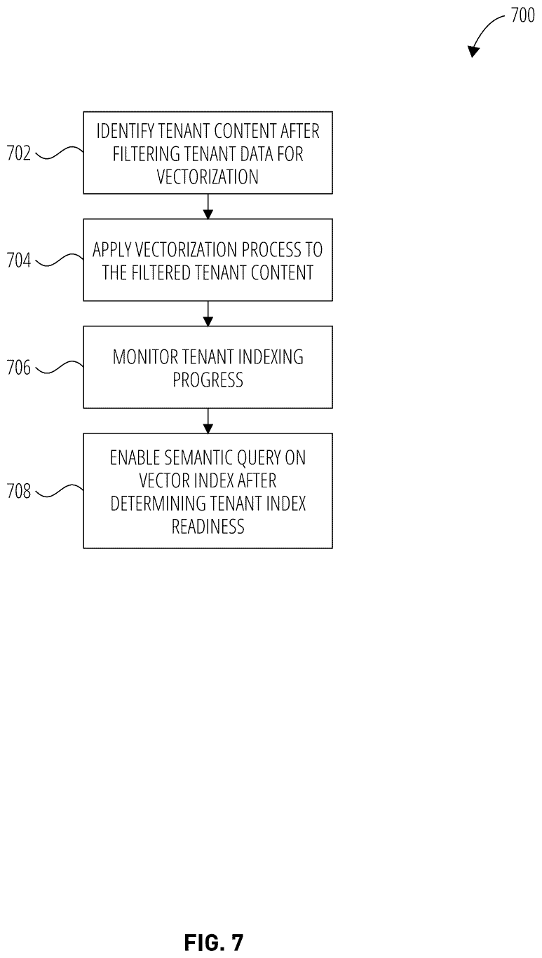

FIG. 7 is a flow diagram illustrating a method for enabling semantic query in accordance with one example embodiment. Operations in the method 700 may be performed by the cloud-based semantic indexing platform 124, using components (e.g., modules, engines) described above with respect to FIG. 2. Accordingly, the method 700 is described by way of example with reference to the cloud-based semantic indexing platform 124. However, it shall be appreciated that at least some of the operations of the method 700 may be deployed on various other hardware configurations or be performed by similar components residing elsewhere. For example, some of the operations may be performed at the client device 106.

At block 702, the cloud-based semantic indexing platform 124 identifies and filters tenant-specific content that is suitable for vectorization. The filtering criteria may include factors such as data type, relevance, and freshness. This ensures that only pertinent and valuable data is processed further. The cloud-based semantic indexing platform 124 identifies which data belongs to which tenant, ensuring that data processing adheres to tenant-specific configurations and privacy requirements.

At block 704, the cloud-based semantic indexing platform 124 a vectorization process to the filtered content. The textual or data content is converted into semantic vectors. These vectors represent the content in a mathematical form that machines can process and understand. In one example, the vectorization process involves the use of advanced natural language processing (NLP) techniques and machine learning models to enhance the semantic understanding of the content.

At block 706, the cloud-based semantic indexing platform 124 continuously monitors the progress of the indexing process to ensure that the vectorization and subsequent steps are proceeding as expected without errors or bottlenecks. In one example, the cloud-based semantic indexing platform 124 adjustments and optimizations can be made (based on the monitoring insights) to improve the efficiency and accuracy of the indexing process.

At block 708, the cloud-based semantic indexing platform 124, before enabling queries, assesses whether the index is ready. This involves checking if a sufficient portion of the tenant's data has been vectorized and indexed. This step checks the completeness of the index. It involves determining whether the indexed data meets the predefined criteria for completeness, which could be based on the volume of data indexed. Once the index is deemed ready, the system enables semantic querying capabilities. This allows users or applications to start querying the indexed data using semantic search techniques.

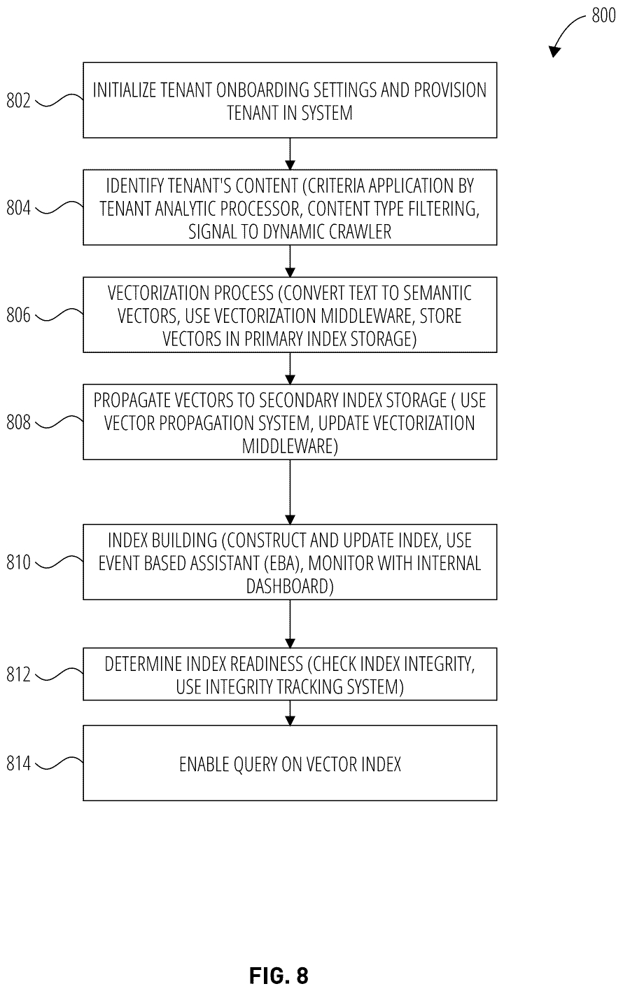

FIG. 8 is a flow diagram illustrating a method for enabling queries on semantic index in accordance with one example embodiment. Operations in the method 700 may be performed by the cloud-based semantic indexing platform 124, using components (e.g., modules, engines) described above with respect to FIG. 2. Accordingly, the method 700 is described by way of example with reference to the cloud-based semantic indexing platform 124. However, it shall be appreciated that at least some of the operations of the method 700 may be deployed on various other hardware configurations or be performed by similar components residing elsewhere. For example, some of the operations may be performed at the client device 106.

At block 802, the cloud-based semantic indexing platform 124 sets up the necessary configurations and parameters specific to a new tenant (for cloud service) in the semantic indexing system. It includes allocating resources, setting access permissions, and initializing data storage settings tailored to the tenant's requirements. Block 802 also includes provisioning the tenant involves registering the tenant in the system's database, establishing a unique tenant ID, and preparing the system's infrastructure to handle the tenant's data.

At block 804, the cloud-based semantic indexing platform 124 identifies and catalogs the tenant's content that will be subject to vectorization. This includes determining the types of content (e.g., documents, emails, multimedia files) and their respective locations within the tenant's data repositories. Criteria application by a tenant analytic processor involves applying predefined filters to select relevant content based on factors such as content age, relevance, and compliance requirements. Content type filtering ensures that only pertinent data types are processed further.

At block 806, the cloud-based semantic indexing platform 124 performs the vectorization process to convert the identified content into semantic vectors. This involves parsing the content, extracting meaningful features, and transforming these features into a vector format that represents the semantic essence of the content. Vectorization middleware is utilized to handle the complexities of the vectorization process, ensuring that it is performed efficiently and accurately. The vectors are then stored in primary index storage, which serves as the initial repository for the newly created semantic vectors.

At block 808, the cloud-based semantic indexing platform 124, once the semantic vectors are stored in the primary index storage, propagates the semantic vectors to a secondary index storage. The vector propagation system ensures that the vectors are copied accurately and efficiently across different storage systems, maintaining data integrity and consistency.

At block 810, the cloud-based semantic indexing platform 124 builds and updates the semantic index using the semantic vectors stored in the secondary index storage. The index building process organizes the vectors in a manner that optimizes query performance and data retrieval. An event-based assistant (EBA) monitors the index building process, applying updates and modifications to the index as new data becomes available or when existing data is updated.

At block 812, the cloud-based semantic indexing platform 124 determines the index readiness for the query. The index readiness is determined by checking the integrity and completeness of the semantic index. This involves ensuring that the index includes all necessary vectors and that it meets predefined performance benchmarks.

At block 814, once the index is deemed ready, this final step involves enabling query capabilities on the vector index. This allows tenants to perform semantic searches and retrieve information based on the indexed data. Enabling queries involves setting the appropriate system flags and permissions, ensuring that tenants can access the semantic index in a secure and controlled manner.

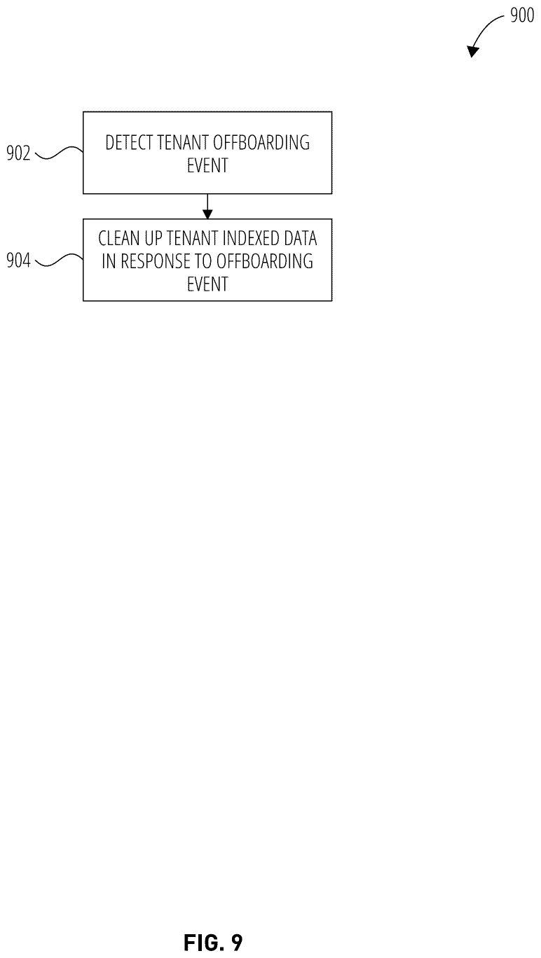

FIG. 9 is a flow diagram illustrating a method for detecting a tenant offboarding event in accordance with one example embodiment. Operations in the method 700 may be performed by the cloud-based semantic indexing platform 124, using components (e.g., modules, engines) described above with respect to FIG. 2. Accordingly, the method 700 is described by way of example with reference to the cloud-based semantic indexing platform 124. However, it shall be appreciated that at least some of the operations of method 700 may be deployed on various other hardware configurations or be performed by similar components residing elsewhere. For example, some of the operations may be performed at the client device 106.

At block 902, this initial step involves the detection of an event indicating that a tenant is offboarding from the semantic indexing platform. This detection triggers the subsequent steps necessary for properly handling the tenant's data. The system continuously monitors signals or flags from the tenant management subsystem, which can include explicit tenant requests for deletion, contract terminations, or other administrative actions that initiate the offboarding process.

At block 904, following the detection of the offboarding event, this step involves the systematic cleanup of all indexed data associated with the tenant. This ensures that the tenant's data is securely and completely removed from the system, maintaining privacy and compliance with data protection regulations.
The cleanup process includes several sub-steps:
   Deletion of Semantic Vectors: All semantic vectors associated with the tenant are located and permanently deleted from both primary and secondary index storages.
   Index Deconstruction: The semantic index structures that contain references to the tenant's data are dismantled and removed.
   Verification of Data Removal: After the deletion processes, the system verifies that no residual data remains in any part of the storage systems. This verification is crucial to ensure the completeness and security of the data removal process.

The final step in the tenant offboarding process involves updating the system status to reflect that the tenant has been successfully offboarded and that their data has been removed. This includes updating administrative logs and system metrics to document the actions taken during the offboarding process. Notifications may be sent to system administrators and relevant stakeholders to confirm the successful completion of the offboarding process. Additionally, this step may involve triggering any necessary processes to reallocate resources previously dedicated to the tenant to other parts of the system.

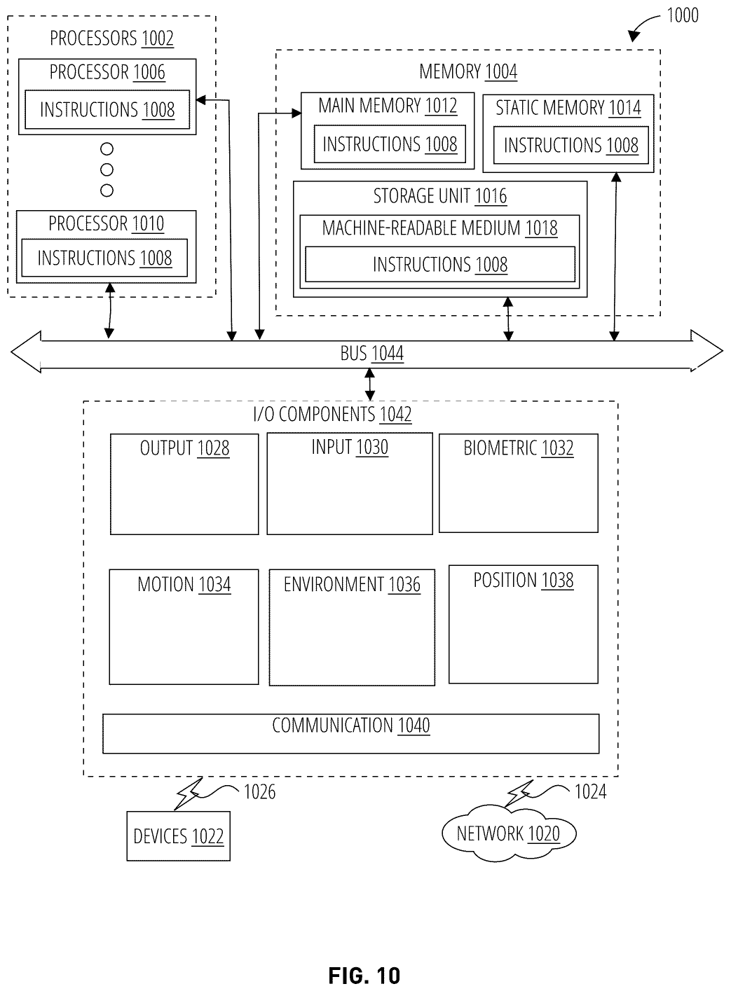

FIG. 10 is a diagrammatic representation of the machine 1000 within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute any one or more of the methods described herein. The instructions 1008 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines that individually or jointly execute the instructions 1008 to perform any one or more of the methodologies discussed herein.

The machine 1000 may include processors 1002, memory 1004, and I/O components 1042, which may be configured to communicate with each other via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1006 and a processor 1010 that execute the instructions 1008. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1012, a static memory 1014, and a storage unit 1016, both accessible to the processors 1002 via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones may include a touch input device or other such input mechanisms, while a headless server machine will likely not include such a touch input device. It will be appreciated that the I/O components 1042 may include many other components that are not shown in FIG. 10. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 include acceleration sensor components (e.g., accelerometer), gravitation sensor components, rotation sensor components (e.g., gyroscope), and so forth. The environmental components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 further include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (e.g., memory 1004, main memory 1012, static memory 1014, and/or memory of the processors 1002) and/or storage unit 1016 may store one or more sets of instructions and data structures (e.g., software) embodying or used by any one or more of the methodologies or functions described herein. These instructions (e.g., the instructions 1008), when executed by processors 1002, cause various operations to implement the disclosed embodiments.

The instructions 1008 may be transmitted or received over the network 1020, using a transmission medium, via a network interface device (e.g., a network interface component included in the communication components 1040) and using any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a method for managing a lifecycle of a semantic index for tenants in a cloud-based environment, the method comprising: detecting a signal indicating a tenant eligibility for semantic indexing; in response to detecting the signal, identifying tenant-specific content for vectorization based on criteria; generating semantic vectors from the identified tenant-specific content and storing the semantic vectors in a primary index storage; propagating the semantic vectors from the primary index storage to a secondary index storage; building a semantic index from the semantic vectors stored in the secondary index storage; and enabling semantic queries on the secondary index storage based on the semantic index.

In Example 2, the subject matter of Example 1 includes, in response to detecting the signal, initiating a bootstrap process for creating the semantic index based on data schema and metadata of the tenant-specific content.

In Example 3, the subject matter of Examples 1-2 includes, wherein identifying tenant-specific content includes selecting content types comprising documents, emails, chats, and images for vectorization.

In Example 4, the subject matter of Examples 1-3 includes, utilizing a scalable vector database to store and query semantic embeddings of items in a graph structure.

In Example 5, the subject matter of Examples 1-4 includes, detecting changes in the identified tenant-specific content by monitoring for additions, deletions, or modifications; vectorizing new or modified data to generate updated semantic vectors corresponding to the changes detected; propagating the updated semantic vectors from the primary index storage to the secondary index storage; applying updates to the semantic index using the updated semantic vectors, wherein the updates modify only portions of the semantic index affected by the changes; and deploying the updated semantic index for querying.

In Example 6, the subject matter of Examples 1-5 includes, detecting a tenant deprovisioning corresponding to the semantic index; and in response to detecting the tenant deprovisioning, deleting the semantic index in the primary index storage and the secondary index storage.

In Example 7, the subject matter of Examples 1-6 includes, wherein enabling the semantic queries further comprises: tracking a completeness or integrity of the semantic index to determine when the index is ready for serving the semantic queries; and activating a semantic query functionality based on the completeness or integrity of the semantic index exceeding a predetermined index completeness threshold.

In Example 8, the subject matter of Examples 1-7 includes, enabling the semantic queries further comprises: monitoring a completeness of the semantic index by calculating a completeness metric based on a percentage of expected data that is present within the semantic index; comparing the calculated completeness metric against a predefined threshold of completeness; and setting a query enablement flag to true when the calculated completeness metric meets or exceeds the predefined threshold of completeness, indicating that the semantic index has reached sufficient completeness to enable the semantic queries.

In Example 9, the subject matter of Examples 1-8 includes, wherein the primary index storage is configured to ingest and process initial data to generate the semantic vectors, and the secondary index storage is configured to replicate and query the semantic vectors, the primary index storage serving as an initial repository for the semantic vectors and responsible for a vectorization process and initial index creation, and the secondary index storage maintaining a copy of the semantic vectors from the primary index storage enabling distributed querying capabilities across the cloud-based environment.

In Example 10, the subject matter of Examples 1-9 includes, continuously monitoring a performance of the semantic queries executed against the semantic index by collecting usage data and query response metrics; analyzing the collected usage data to identify patterns in the semantic index's performance and a relevance of query results; adjusting parameters of the semantic index based on the analyzing of the collected usage data to enhance an accuracy and efficiency of the semantic queries, wherein the adjustments include modifications to vectorization algorithms, index structure, or query processing methods; and implementing performance tuning measures that are responsive to the analyzing.

Example 11 is a computing apparatus comprising: a processor; and a memory storing instructions that, when executed by the processor, configure the apparatus to perform operations comprising: detect a signal indicating a tenant eligibility for semantic indexing; in response to detecting the signal, identify tenant-specific content for vectorization based on criteria; generate semantic vectors from the identified tenant-specific content and storing the semantic vectors in a primary index storage; propagate the semantic vectors from the primary index storage to a secondary index storage; build a semantic index from the semantic vectors stored in the secondary index storage; and enable semantic queries on the secondary index storage based on the semantic index.

In Example 12, the subject matter of Example 11 includes, wherein the instructions further configure the apparatus to: in response to detecting the signal, initiate a bootstrap process for creating the semantic index based on data schema and metadata of the tenant-specific content.

In Example 13, the subject matter of Examples 11-12 includes, wherein identifying tenant-specific content includes select content types comprising documents, emails, chats, and images for vectorization.

In Example 14, the subject matter of Examples 11-13 includes, wherein the instructions further configure the apparatus to: utilize a scalable vector database to store and query semantic embeddings of items in a graph structure.

In Example 15, the subject matter of Examples 11-14 includes, wherein the instructions further configure the apparatus to: detect changes in the identified tenant-specific content by monitoring for additions, deletions, or modifications; vectorizing new or modified data to generate updated semantic vectors corresponding to the changes detected; propagate the updated semantic vectors from the primary index storage to the secondary index storage; apply updates to the semantic index using the updated semantic vectors, wherein the updates modify only portions of the semantic index affected by the changes; and deploy the updated semantic index for querying.

In Example 16, the subject matter of Examples 11-15 includes, wherein the instructions further configure the apparatus to: detect a tenant deprovisioning corresponding to the semantic index; and in response to detecting the tenant deprovision, deleting the semantic index in the primary index storage and the secondary index storage.

In Example 17, the subject matter of Examples 11-16 includes, wherein enabling the semantic queries further comprises: track a completeness or integrity of the semantic index to determine when the index is ready for serving the semantic queries; and activate a semantic query functionality based on the completeness or integrity of the semantic index exceeding a predetermined index completeness threshold.

In Example 18, the subject matter of Examples 11-17 includes, enable the semantic queries further comprises: monitor a completeness of the semantic index by calculating a completeness metric based on a percentage of expected data that is present within the semantic index; compare the calculated completeness metric against a predefined threshold of completeness; and set a query enablement flag to true when the calculated completeness metric meets or exceeds the predefined threshold of completeness, indicating that the semantic index has reached sufficient completeness to enable the semantic queries.

In Example 19, the subject matter of Examples 11-18 includes, wherein the primary index storage is configured to ingest and process initial data to generate the semantic vectors, and the secondary index storage is configured to replicate and query the semantic vectors, the primary index storage serve as an initial repository for the semantic vectors and responsible for a vectorization process and initial index creation, and the secondary index storage maintain a copy of the semantic vectors from the primary index storage enabling distributed querying capabilities across the cloud-based environment.

Example 20 is a non-transitory computer-readable storage medium, the computer-readable storage medium including instructions that when executed by a computer, cause the computer to: detect a signal indicating a tenant eligibility for semantic indexing; in response to detecting the signal, identify tenant-specific content for vectorization based on criteria; generate semantic vectors from the identified tenant-specific content and store the semantic vectors in a primary index storage; propagate the semantic vectors from the primary index storage to a secondary index storage; build a semantic index from the semantic vectors stored in the secondary index storage; and enable semantic queries on the secondary index storage based on the semantic index.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for managing a lifecycle of a semantic index for tenants in a cloud-based environment, the method comprising:
detecting a signal indicating a tenant eligibility for semantic indexing;
in response to detecting the signal, identifying tenant-specific content for vectorization based on criteria;
generating semantic vectors from the identified tenant-specific content and storing the semantic vectors in a primary index storage;
propagating the semantic vectors from the primary index storage to a secondary index storage;
building a semantic index from the semantic vectors stored in the secondary index storage; and
enabling semantic queries on the secondary index storage based on the semantic index.

2. The method of claim 1, further comprising: in response to detecting the signal, initiating a bootstrap process for creating the semantic index based on data schema and metadata of the tenant-specific content.

3. The method of claim 1, wherein identifying tenant-specific content includes selecting content types comprising documents, emails, chats, and images for vectorization.

4. The method of claim 1, further comprising: utilizing a scalable vector database to store and query semantic embeddings of items in a graph structure.

5. The method of claim 1, further comprising:
detecting changes in the identified tenant-specific content by monitoring for additions, deletions, or modifications;
vectorizing new or modified data to generate updated semantic vectors corresponding to the changes detected;
propagating the updated semantic vectors from the primary index storage to the secondary index storage;
applying updates to the semantic index using the updated semantic vectors, wherein the updates modify only portions of the semantic index affected by the changes; and
deploying the updated semantic index for querying.

6. The method of claim 1, further comprising:
detecting a tenant deprovisioning corresponding to the semantic index; and
in response to detecting the tenant deprovisioning, deleting the semantic index in the primary index storage and the secondary index storage.

7. The method of claim 1, wherein enabling the semantic queries further comprises:
tracking a completeness or integrity of the semantic index to determine when the index is ready for serving the semantic queries; and
activating a semantic query functionality based on the completeness or integrity of the semantic index exceeding a predetermined index completeness threshold.

8. The method of claim 1, enabling the semantic queries further comprises:
monitoring a completeness of the semantic index by calculating a completeness metric based on a percentage of expected data that is present within the semantic index;
comparing the calculated completeness metric against a predefined threshold of completeness; and
setting a query enablement flag to true when the calculated completeness metric meets or exceeds the predefined threshold of completeness, indicating that the semantic index has reached sufficient completeness to enable the semantic queries.

9. The method of claim 1, wherein the primary index storage is configured to ingest and process initial data to generate the semantic vectors, and the secondary index storage is configured to replicate and query the semantic vectors,
the primary index storage serving as an initial repository for the semantic vectors and responsible for a vectorization process and initial index creation, and
the secondary index storage maintaining a copy of the semantic vectors from the primary index storage enabling distributed querying capabilities across the cloud-based environment.

10. The method of claim 1, further comprising:
continuously monitoring a performance of the semantic queries executed against the semantic index by collecting usage data and query response metrics;
analyzing the collected usage data to identify patterns in the semantic index's performance and a relevance of query results;
adjusting parameters of the semantic index based on the analyzing of the collected usage data to enhance an accuracy and efficiency of the semantic queries, wherein the adjustments include modifications to vectorization algorithms, index structure, or query processing methods; and
implementing performance tuning measures that are responsive to the analyzing.

11. A computing apparatus comprising:
a processor; and
a memory storing instructions that, when executed by the processor, configure the apparatus to perform operations comprising:
detect a signal indicating a tenant eligibility for semantic indexing;
in response to detecting the signal, identify tenant-specific content for vectorization based on criteria;
generate semantic vectors from the identified tenant-specific content and storing the semantic vectors in a primary index storage;
propagate the semantic vectors from the primary index storage to a secondary index storage;
build a semantic index from the semantic vectors stored in the secondary index storage; and
enable semantic queries on the secondary index storage based on the semantic index.

12. The computing apparatus of claim 11, wherein the instructions further configure the apparatus to: in response to detecting the signal, initiate a bootstrap process for creating the semantic index based on data schema and metadata of the tenant-specific content.

13. The computing apparatus of claim 11, wherein identifying tenant-specific content includes select content types comprising documents, emails, chats, and images for vectorization.

14. The computing apparatus of claim 11, wherein the instructions further configure the apparatus to: utilize a scalable vector database to store and query semantic embeddings of items in a graph structure.

15. The computing apparatus of claim 11, wherein the instructions further configure the apparatus to:
detect changes in the identified tenant-specific content by monitoring for additions, deletions, or modifications;
vectorizing new or modified data to generate updated semantic vectors corresponding to the changes detected;
propagate the updated semantic vectors from the primary index storage to the secondary index storage;
apply updates to the semantic index using the updated semantic vectors, wherein the updates modify only portions of the semantic index affected by the changes; and
deploy the updated semantic index for querying.

16. The computing apparatus of claim 11, wherein the instructions further configure the apparatus to:
detect a tenant deprovisioning corresponding to the semantic index; and
in response to detecting the tenant deprovision, deleting the semantic index in the primary index storage and the secondary index storage.

17. The computing apparatus of claim 11, wherein enabling the semantic queries further comprises:
track a completeness or integrity of the semantic index to determine when the index is ready for serving the semantic queries; and
activate a semantic query functionality based on the completeness or integrity of the semantic index exceeding a predetermined index completeness threshold.

18. The computing apparatus of claim 11, enable the semantic queries further comprises:
monitor a completeness of the semantic index by calculating a completeness metric based on a percentage of expected data that is present within the semantic index;
compare the calculated completeness metric against a predefined threshold of completeness; and
set a query enablement flag to true when the calculated completeness metric meets or exceeds the predefined threshold of completeness, indicating that the semantic index has reached sufficient completeness to enable the semantic queries.

19. The computing apparatus of claim 11, wherein the primary index storage is configured to ingest and process initial data to generate the semantic vectors, and the secondary index storage is configured to replicate and query the semantic vectors,
the primary index storage serve as an initial repository for the semantic vectors and responsible for a vectorization process and initial index creation, and
the secondary index storage maintain a copy of the semantic vectors from the primary index storage enabling distributed querying capabilities across the cloud-based environment.

20. A non-transitory computer-readable storage medium, the computer-readable storage medium including instructions that when executed by a computer, cause the computer to:
detect a signal indicating a tenant eligibility for semantic indexing;
in response to detecting the signal, identify tenant-specific content for vectorization based on criteria;
generate semantic vectors from the identified tenant-specific content and store the semantic vectors in a primary index storage;
propagate the semantic vectors from the primary index storage to a secondary index storage;
build a semantic index from the semantic vectors stored in the secondary index storage; and
enable semantic queries on the secondary index storage based on the semantic index.
